(19) United States
(12) Patent Application Publication
(10) Pub. No.: US 2013/0134341 A1
(43) Pub. Date: May 30, 2013

(54) Hydraulic rotary valve

(71) Applicant: JUI-YUAN CHENG, Nantou County (TW)

(72) Inventor: JUI-YUAN CHENG, Nantou County (TW)

(21) Appl. No.: 13/308,438

(22) Filed: Nov. 30, 2011

(51) Int. Cl. F16K 5/00

(52) U.S. Cl. 251/304

(57) ABSTRACT

A hydraulic rotary valve comprises a valve body formed with a plurality of outer ports and a spool rotatably disposed in the valve body, and the spool is formed with a plurality of inner ports. The spool is capable of rotating at least three angles with respect to the spool to enable the respective outer ports of the valve body to be in or not in communication with the respective inner ports of the spool, thus making the hydraulic liquid flow in desired directions to control predetermined motions of an actuator. The hydraulic rotary valve is easy to manufacture, and has less leakage and less pressure loss problem.

### BACKGROUND OF THE INVENTION

1. Field of the Invention

The present invention relates to a control valve used in a hydraulic system, and more particularly to a hydraulic rotary valve.

2. Description of the Prior Art

Conventional direction control valves are mainly used to control the flow direction of the hydraulic liquid in order to achieve a desired motion, such as the back and forth of the hydraulic cylinder, and the rotation and reverse rotation of the hydraulic motor.

Referring to FIG. 1, a conventional direction control valve (4 ports 3 positions) essentially comprises a valve body 11 and spool 12. The valve body 11 is formed with a slide space 111, a P port 112 which is in communication with the slide space 111 and connected to a hydraulic liquid source 13, a T port 113 which is in communication with the slide space 111 and connected to an oil tank 14, a B port 114 which is in communication with the slide space 111 and connected to the forward port 151 of an oil cylinder 15, and an A port 115 which is in communication with the slide space 111 and connected to a backward port 152 of the oil cylinder 15. The spool 12 moves to selectively seal the P port 112, T port 113, A port 115 and B port 114 of the valve body 11, so as to make the hydraulic liquid move in the desired directions, and consequently controlling the switching direction of the oil cylinder 15.

However, since the spool 12 moves in the valve body 11 in a linear manner to control switch of flow direction, which requires a high accuracy of fit between the spool 12 and the valve body 11, and has the disadvantages of relatively large leakage and pressure loss. Further, it should also require the use of an oil circuit block, which not only increases the size of the pressure system, but also increases the manufacturing cost.

The present invention has arisen to mitigate and/or obviate the afore-described disadvantages.

### SUMMARY OF THE INVENTION

The primary object of the present invention is to provide a hydraulic rotary valve which is easy to manufacture, and has less leakage and less pressure loss problem.

Another object of the present invention is to provide a hydraulic rotary valve which doesn't requires the use of oil circuit block.

To achieve the above objects, the hydraulic rotary valve comprises a valve body formed with a plurality of outer ports and a spool rotatably disposed in the valve body, and the spool is formed with a plurality of inner ports. The spool is capable of rotating at least three angles with respect to the spool to enable the respective outer ports of the valve body to be in or not in communication with the respective inner ports of the spool, thus making the hydraulic liquid flow in desired directions to control predetermined motions of an actuator.

### BRIEF DESCRIPTION OF THE DRAWINGS

FIG. 1 is cross sectional view of a conventional direction control valve;

FIG. 2 is an exploded view of a hydraulic rotary valve in accordance with the present invention;

FIG. 3 is an assembly view of the hydraulic rotary valve in accordance with the present invention;

FIG. 4 is a perspective view in accordance with the present invention, showing the interior of the valve body;

FIG. 5 is a perspective view in accordance with the present invention, showing the interior of a spool;

FIG. 6 shows that the spool in accordance with the present invention is rotated to a first angle;

FIG. 7 is a cross sectional view taken along the line 7-7 of FIG. 6;

FIG. 8 is an unfolded view of the valve body and the spool in accordance with the present invention;

FIG. 9 shows that the spool is rotated to the position of a second angle;

FIG. 10 is a cross sectional view taken along the line 10-10 of FIG. 9;

FIG. 11 is an unfolded view of the valve body and the spool in accordance with the present invention when the spool is rotated to the second angle;

FIG. 12 shows that the spool in accordance with the present invention is rotated to the position of a third angle;

FIG. 13 is a cross sectional view taken along the line 13-13 of FIG. 12;

FIG. 14 is an unfolded view of the valve body and the spool in accordance with the present invention when the spool is rotated to the third angle;

FIG. 15 is an unfolded view of the valve body and the spool in accordance with the present invention, showing that the inner ports of the spool are partially in communication with the outer ports of the valve body to control the flow rate;

FIG. 16 is a cross sectional view of a valve body in accordance with the present invention, showing that the first and second hydraulic liquid source ports are not in communication with each other;

FIG. 17 is a cross sectional view of a valve body in accordance with the present invention, showing that the first and second hydraulic liquid source ports are in communication with each other;

FIG. 18 is an exploded view of another embodiment of the present invention;

FIG. 19 is an exploded view of another embodiment of the present invention, showing that the valve body and the spool are formed with pressure balance ports;

FIG. 20 is an assembly view of a hydraulic rotary valve of another embodiment of the present invention;

FIG. 21 is a cross sectional view taken along the line of FIG. 20;

FIG. 22 is an unfolded view of the valve body and the spool in accordance with another embodiment of the present invention, showing that the spool is rotated to the first angle;

FIG. 23 is an unfolded view of a hydraulic rotary valve with M type neutral position function in accordance with the present invention;

FIG. 24 is an unfolded view of a hydraulic rotary valve with YP type neutral position function in accordance with the present invention;

FIG. 25 is an unfolded view of another hydraulic rotary valve with M type neutral position function in accordance with the present invention;

FIG. 26 is an unfolded view of a hydraulic rotary valve with H type neutral position function in accordance with the present invention;

FIG. 27 is an unfolded view of a hydraulic rotary valve with K type neutral position function in accordance with the present invention;

FIG. 28 is an unfolded view of a hydraulic rotary valve with P type neutral position function in accordance with the present invention;

FIG. 29 is an unfolded view of a hydraulic rotary valve with D type neutral position function in accordance with the present invention;

FIG. 30 is an unfolded view of a hydraulic rotary valve with J type neutral position function in accordance with the present invention;

FIG. 31 is an unfolded view of a hydraulic rotary valve with N type neutral position function in accordance with the present invention;

FIG. 32 is an unfolded view of a hydraulic rotary valve with C type neutral position function in accordance with the present invention;

FIG. 33 is an unfolded view of a hydraulic rotary valve with Y type neutral position function in accordance with the present invention;

FIG. 34 is an unfolded view of a hydraulic rotary valve with PY type neutral position function in accordance with the present invention;

FIG. 35 is an exploded view of another embodiment of the present invention; and

FIG. 36 shows another embodiment of the present invention, wherein a block is provided with 3 receiving spaces for receiving 3 hydraulic rotary valves.

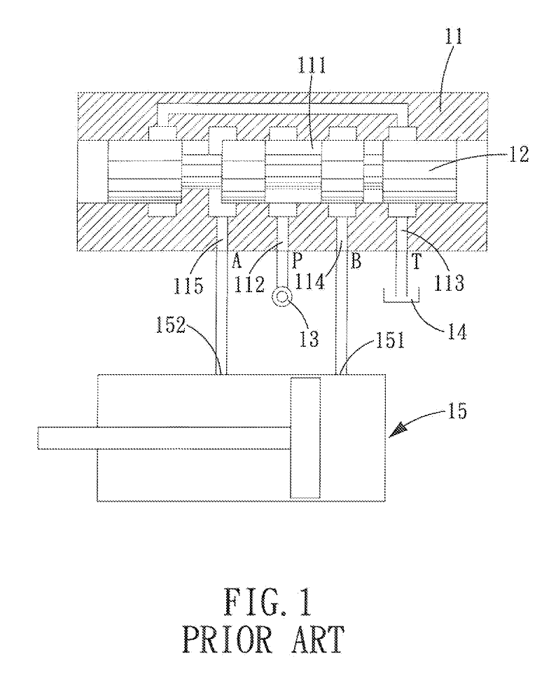

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

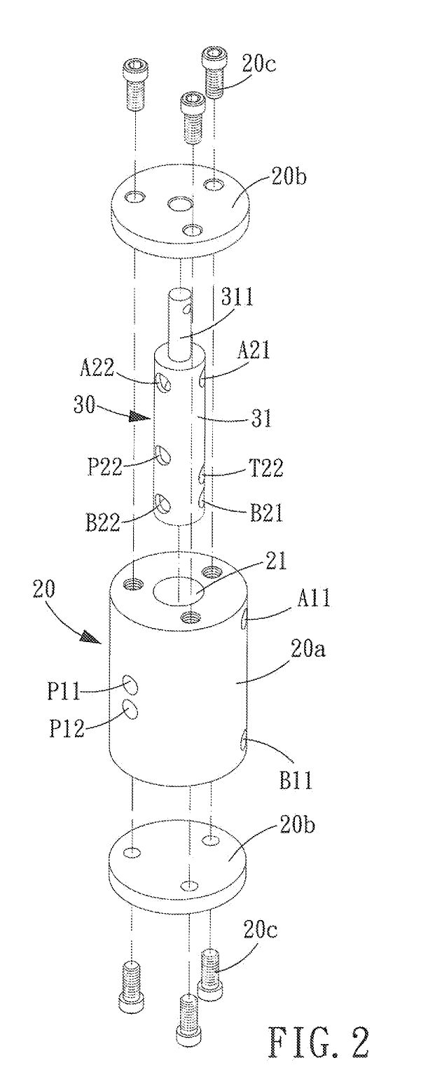

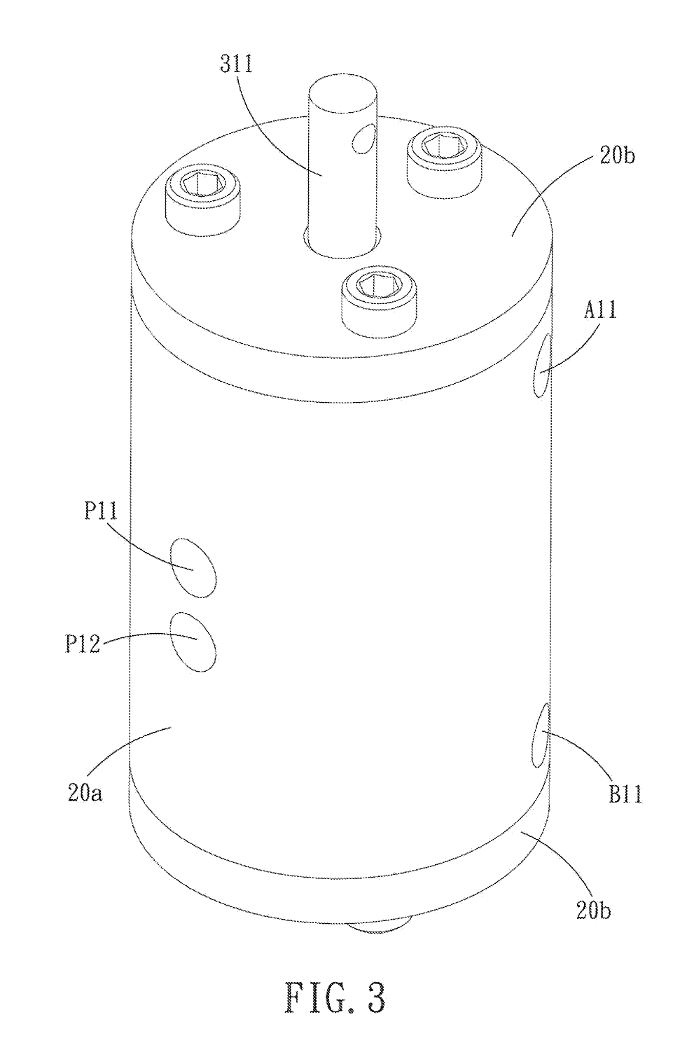

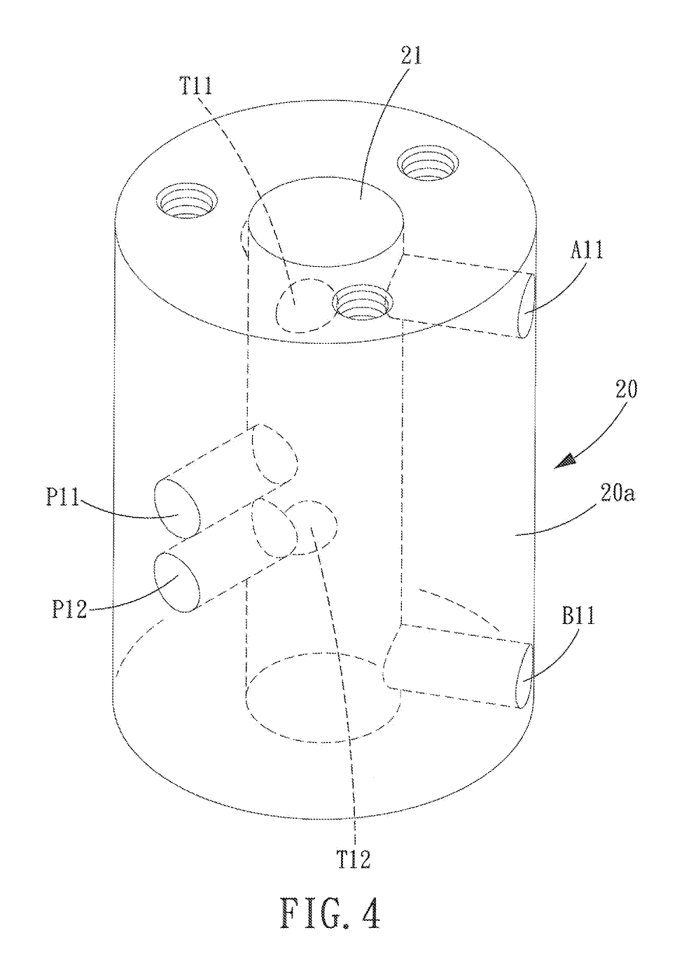

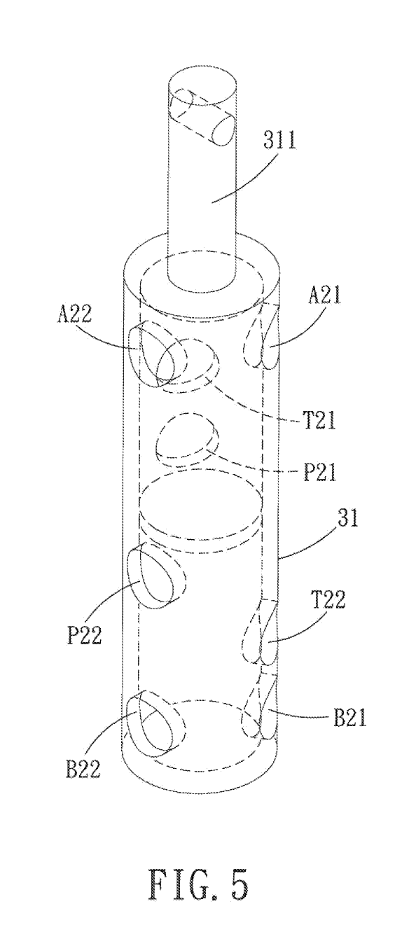

Referring to FIGS. 2-5, a hydraulic rotary valve in accordance with the present invention comprises a valve body 20 and a spool 30.

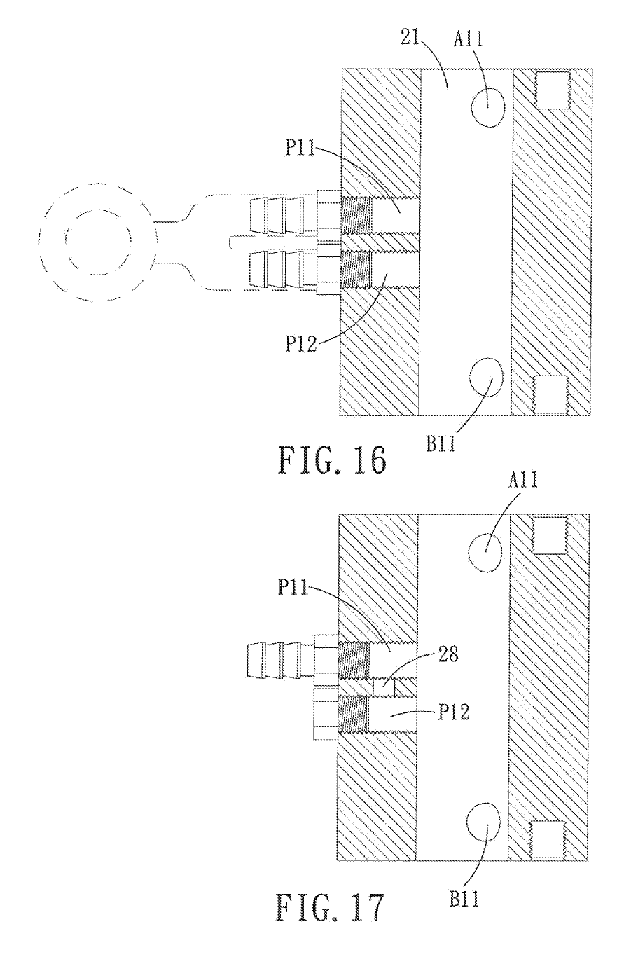

The valve body 20 includes a rotary space 21, a first hydraulic liquid source outer port P11, a second hydraulic liquid source outer port P12, a first oil tank outer port T11, a second oil tank outer port T12, a first drive outer port All and a second drive outer port B11, which are connected to outside and the rotary space 21. In this embodiment, the valve body 20 comprises a body 20a and two covers 20b fixed to both ends of the body 20a by screws 20c. The rotary space 21, the first and second hydraulic liquid source outer ports P11, P12, the first and second oil tank outer ports T11, T12, and the first and second drive outer ports A11, B11 are all formed in the body 20a. it is to be noted that the first and second hydraulic liquid source outer ports P11, P12 are not in communication with each other and connected to the same hydraulic liquid source, so that the pressure of the first hydraulic liquid source outer port P11 is the same as that of the second hydraulic liquid source outer port P12 (as shown in FIG. 16). Furthermore, in accordance with another embodiment of the present invention, between the first and second hydraulic liquid source outer ports P11, P12 can be connected a passage 28, so that it can connect the hydraulic liquid source to only one of the first and second hydraulic liquid source outer ports P11, P12, and the first and second hydraulic liquid source outer ports P11, P12 will also have equal pressure (as shown in FIG. 17).

The spool 30 is rotatable received in the rotary space 21 of the valve body 20 and includes an axial portion 31, a control portion 311 extending from the axial portion 31 and into the rotary space 21, a first hydraulic liquid source inner port P21, a first oil tank inner port T21, a first drive inner port A21 and a second drive inner port A22, which are in communication with one another and formed in the axial portion 31, and a second hydraulic liquid source inner port P22, a second oil tank inner port T22, a third drive inner port B21 and a fourth drive inner port B22 which are in communication with one another and formed in the axial portion 31. The spool 30 is capable of rotating three angles with respect to the valve body 20 to enable the respective outer ports of the valve body 20 to be in or not in communication with the respective inner ports of the spool 30, thus making the hydraulic liquid flow in the desired direction to control the specific motion of the actuator, such as the back and forth movement of the hydraulic cylinder, the forward and reverse rotation of the hydraulic motor. It is to be noted that the relative rotation of the spool 30 with respect to the valve body 20 can be done by using solenoid valve, step motor or servo motor to drive the control portion 311 to rotate, and thus the spool 30 can be adjusted a predetermined angle with respect to the valve body 20.

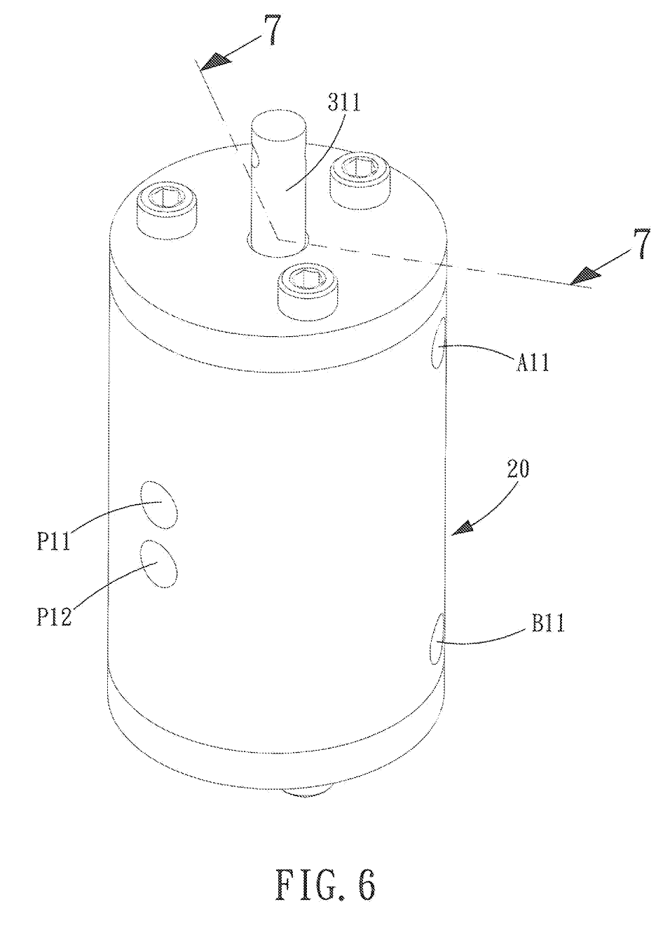

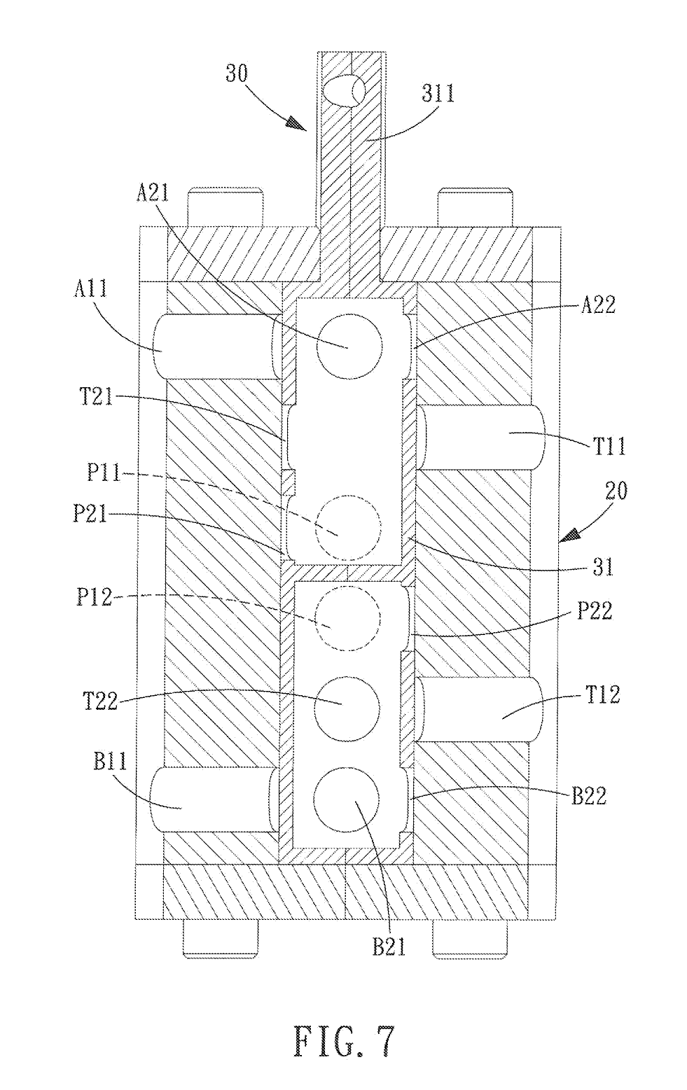

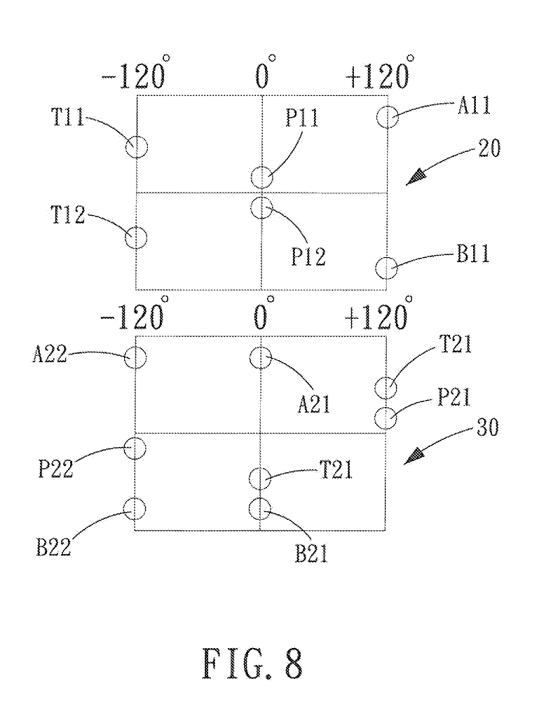

Referring to FIGS. 6-8, wherein FIG. 6 shows that the spool 30 is rotated to a first angle, FIG. 7 is cross sectional view taken along the line 7-7 of FIG. 6, and FIG. 8 is an unfolded view of the valve body 20 and the spool 30. When the spool 30 is rotated to the first angle (0 degree), namely to the neutral position, the respective inner ports of the spool 30 are not in communication with the respective outer ports of the valve body 20, and at this moment, the neutral position function is O type, and the hydraulic liquid of the hydraulic liquid source cannot be outputted out the actuator, so as to make the actuator perform predetermined action.

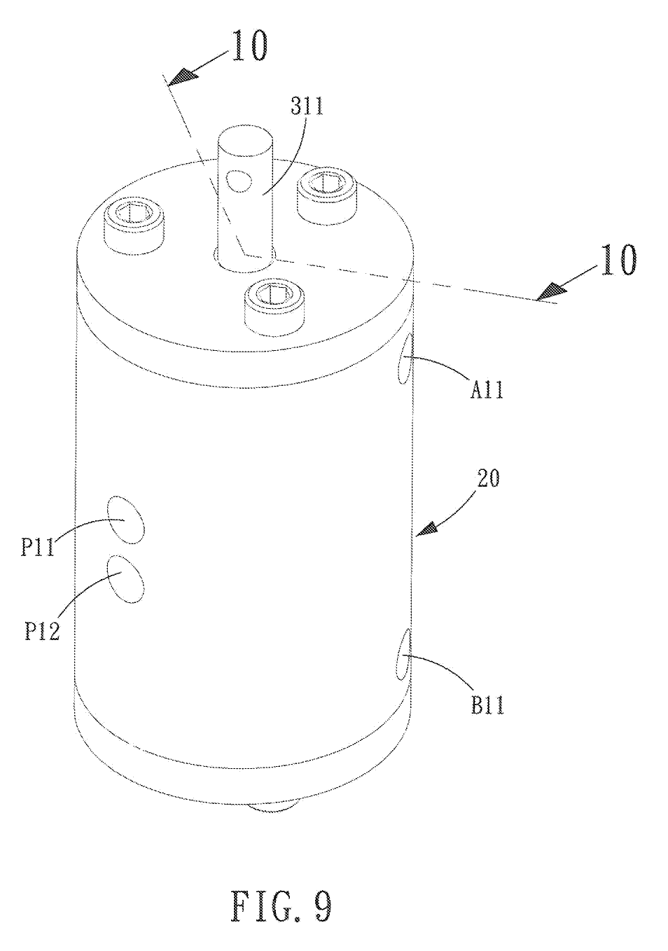

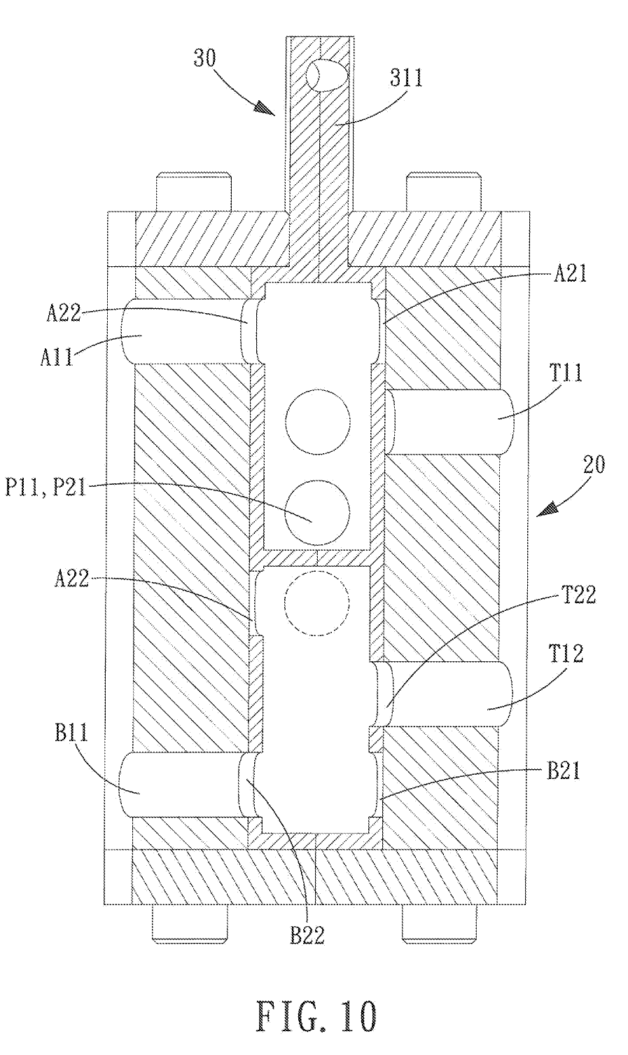

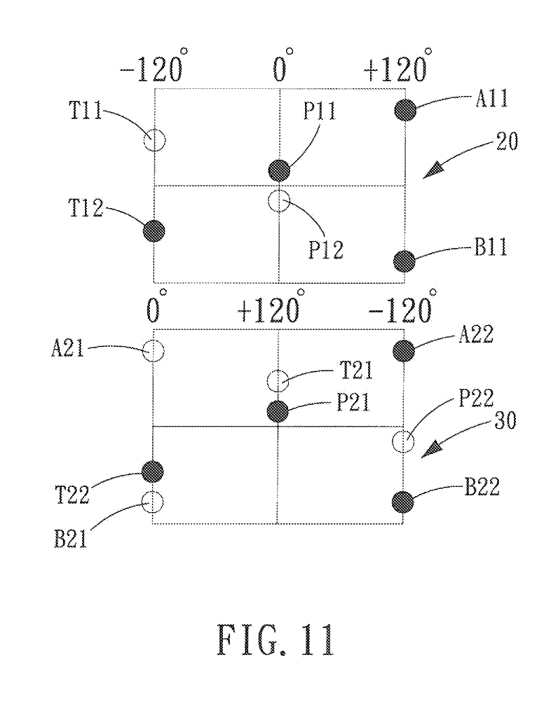

Referring to FIGS. 9-11, wherein FIG. 9 shows that the spool 30 is rotated to the position of a second angle, FIG. 10 is a cross sectional view taken along the line 10-10 of FIG. 9, and FIG. 11 is an unfolded view of the valve body 20 and the spool 30, wherein the valve body 20 doesn't rotate (0 degree), the spool 30 rotates 120 degrees in forward direction to a position where the inner ports are in communication with the outer ports and are filled with black color to show the communication state. When the spool 30 rotates to the second angle (120 degrees), the first hydraulic liquid source inner port P21 is in communication with the first hydraulic liquid source outer port P11, the second drive inner port A22 is in communication with the first drive outer port A11, the second oil tank inner port T22 is in communication with the second oil tank outer port T12, and the fourth drive inner port B22 is in communication with the second drive outer port B11. At this moment, the hydraulic liquid of the hydraulic liquid source can be transported to the actuator by the rotary valve of the present invention to make the actuator perform predetermined motion. The flow route of the hydraulic liquid flowing through the valve body 20 is such that: the hydraulic liquid from the hydraulic liquid source enters the first hydraulic liquid source outer port P11 and is outputted out of the first drive outer port A11, and then flows to the actuator to make the actuator perform a motion in a predetermined direction. After the actuator finishes performing the predetermined action, the hydraulic liquid will flow into the second drive outer port B11 and out of the second oil tank outer port T12 and finally flows back to the oil tank.

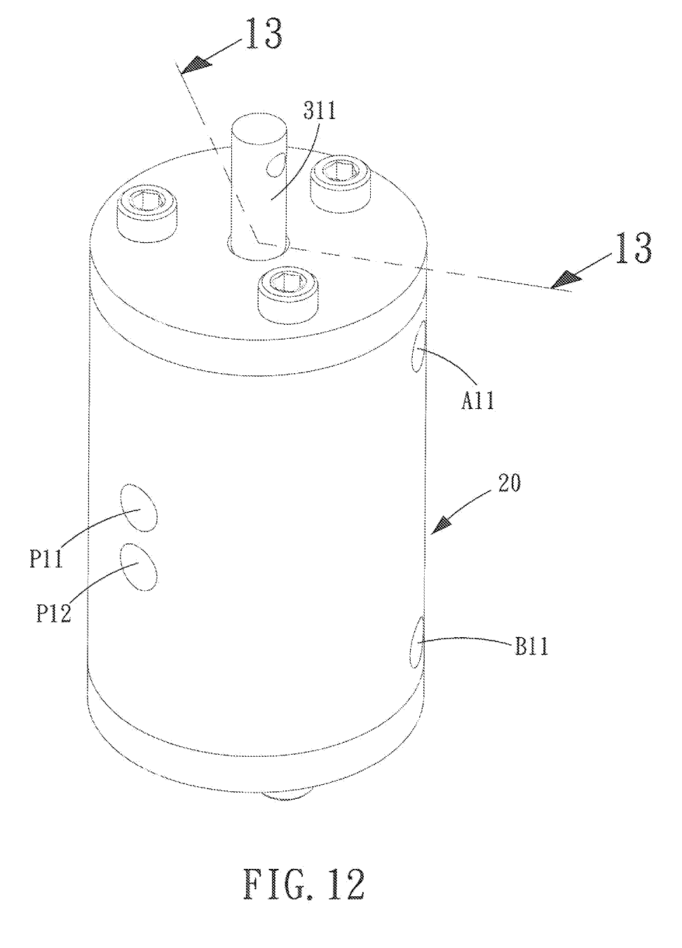

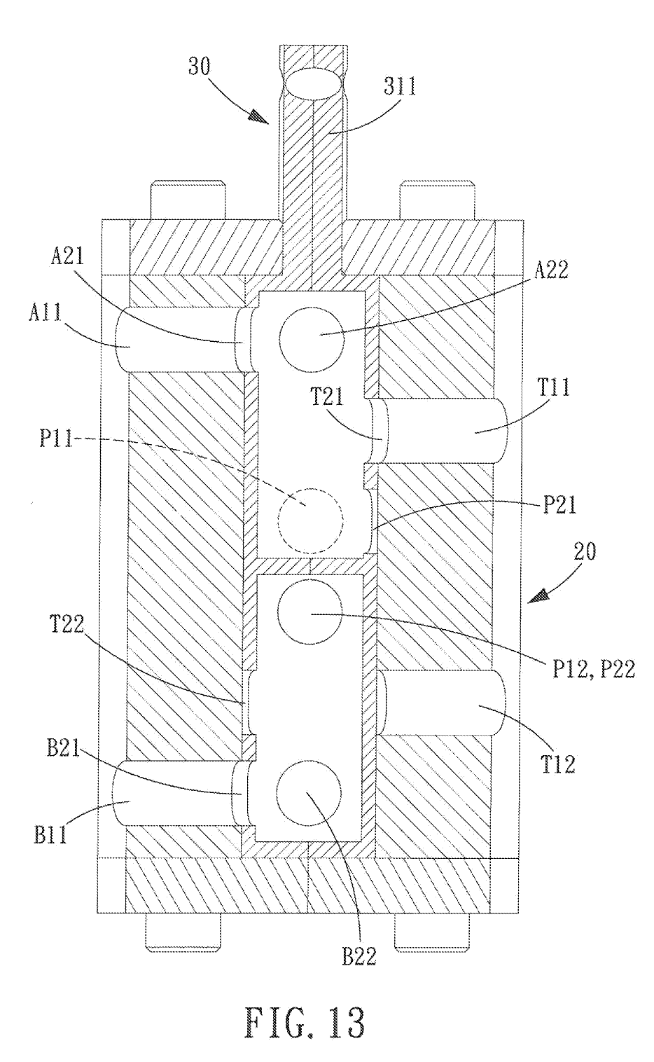

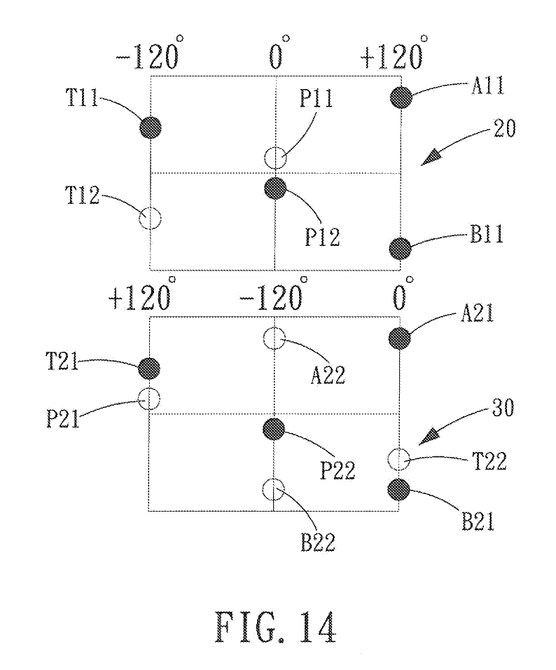

Referring to FIGS. 12-14, wherein FIG. 12 shows that the spool 30 is rotated to the position of a third angle, FIG. 13 is a cross sectional view taken along the line 13-13 of FIG. 12, and FIG. 14 is an unfolded view of the valve body 20 and the spool 30, wherein the valve body 20 doesn't rotate (0 degree), the spool 30 rotates 120 degrees in forward direction to a position where the inner ports are in communication with the outer ports and are filled with black color to show the communication state. When the spool 30 is rotated to a third angle (−120 degrees), the first oil tank inner port T21 is in communication with the first oil tank outer port T11, the first drive inner port A21 is in communication with the first drive outer port A11, the second hydraulic liquid source inner port P22 is in communication with a second hydraulic liquid source outer port P12, and the third drive inner port B21 is in communication with the second drive outer port B11. At this moment, the hydraulic liquid of the hydraulic liquid source can be transported to the actuator by the rotary valve of the present invention to make the actuator perform predetermined motion. The flow route of the hydraulic liquid flowing through the valve body 20 is such that: the hydraulic liquid from the hydraulic liquid source enters the second hydraulic liquid source outer port P12 and is outputted out of the second drive outer port B11, and then flows to the actuator to make the actuator perform a motion in a predetermined direction. After the actuator finishes performing the predetermined action, the hydraulic liquid of the actuator will flow into the first drive outer port A11 and out of the first oil tank outer port T11 and finally flows back to the oil tank.

It is clear from the above mentioned description that assembling the spool 30 in the valve body 20 in a rotary manner can make the actuator perform the predetermined motions, and the valve body 20 and the spool 30 are easy to manufacture. Furthermore, the valve structure with the spool 30 rotatably disposed in the valve body 20 has less leakage and less pressure loss, and doesn't need the use of oil circuit block, so that the whole hydraulic system can be reduced in weight, size and cost.

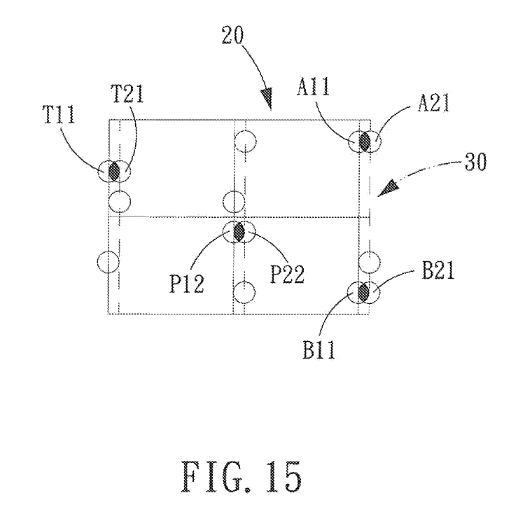

It is to be noted that when the spool 30 is driven by a step motor or servo motor to rotate with respect to the valve body 20, the rotating angle of the spool 30 is controllable, namely, the overlapped area between the inner ports and the outer ports for allowing the hydraulic liquid to flow through can be controlled, so that the flow rate can be controlled. For example, as shown in FIG. 15 which shows the unfolded state of the valve body 20 and the spool 30, the valve body 20 doesn't rotate (0 degree), and the spool 30 rotates a specific angle to a position where the inner ports are in communication with the outer ports in such a manner that the first oil tank inner port T21 is partially in communication with the first oil tank outer port T11, the first drive inner port A21 is partially in communication with the first drive outer port A11, the second hydraulic liquid source inner port P22 is partially in communication with the second hydraulic liquid source outer port P12, and the third drive inner port B21 is partially in communication with the second drive outer port B11. Hence, the flow rate is controlled. The overlapped areas between the ports are filled with black color to show the communication state.

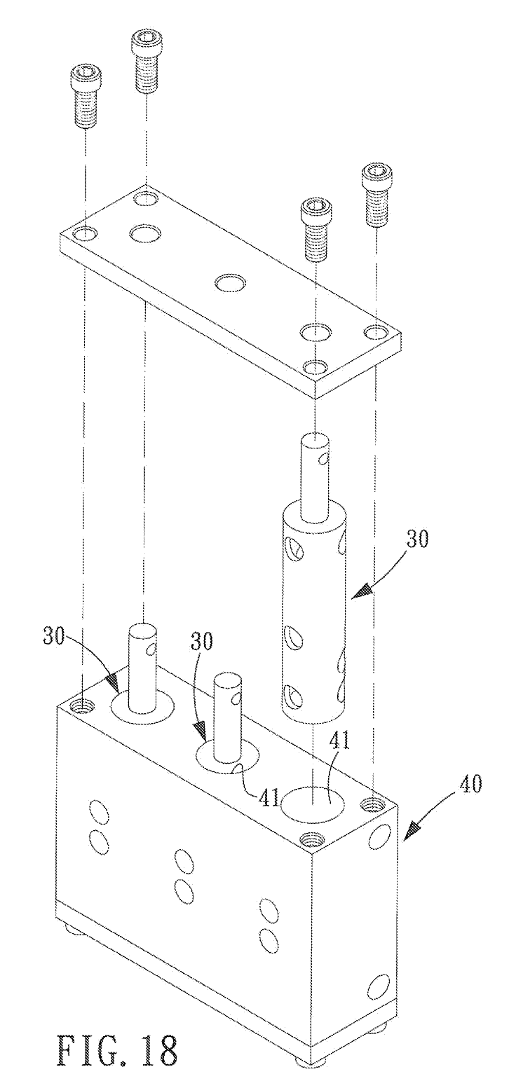

Referring to FIG. 18, a hydraulic rotary valve in accordance with another embodiment of the present invention also comprises a valve body 40 and is similar to the previous embodiment except that: the valve body 40 is formed with three rotary spaces 41 to accommodate three spools 30, so that a single hydraulic rotary valve is capable of controlling multiple actuators.

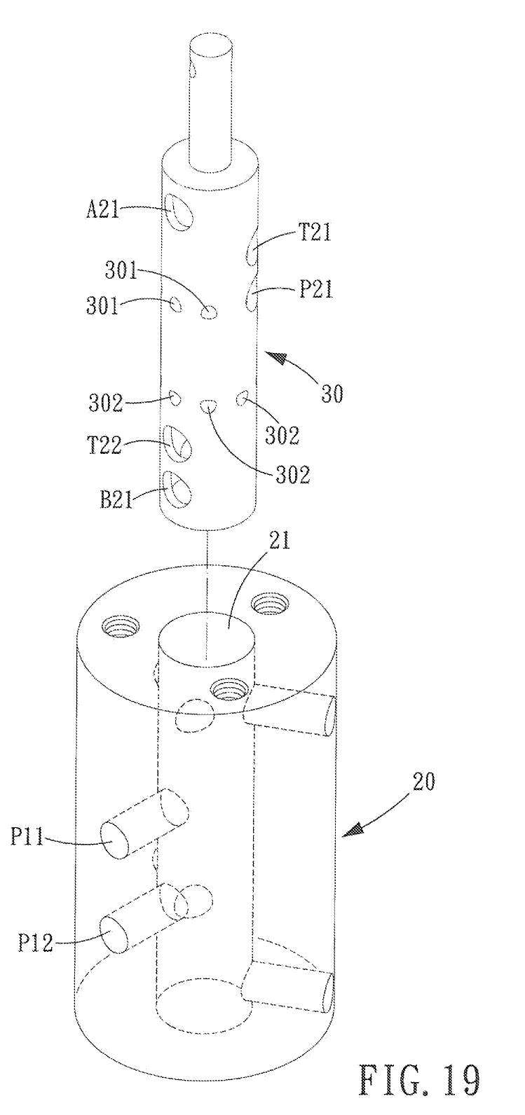

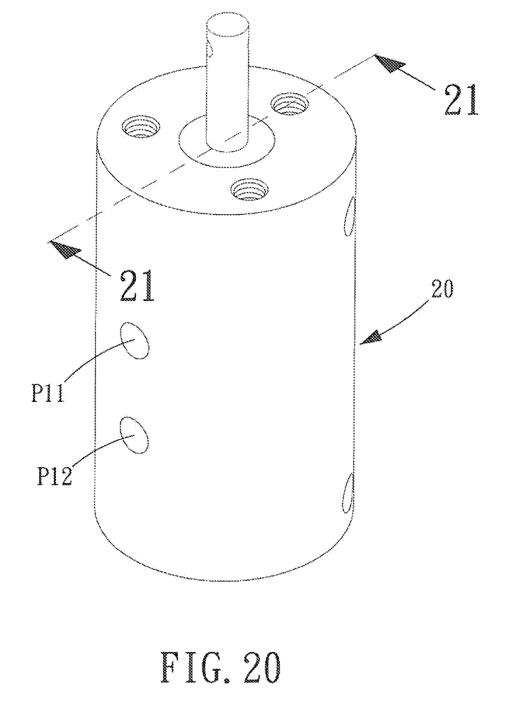

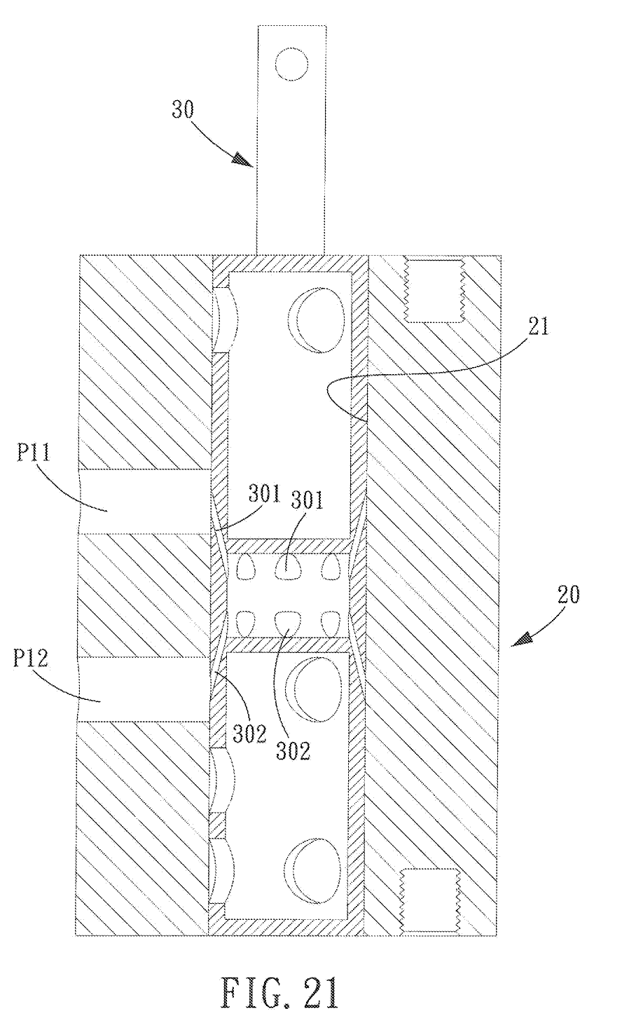

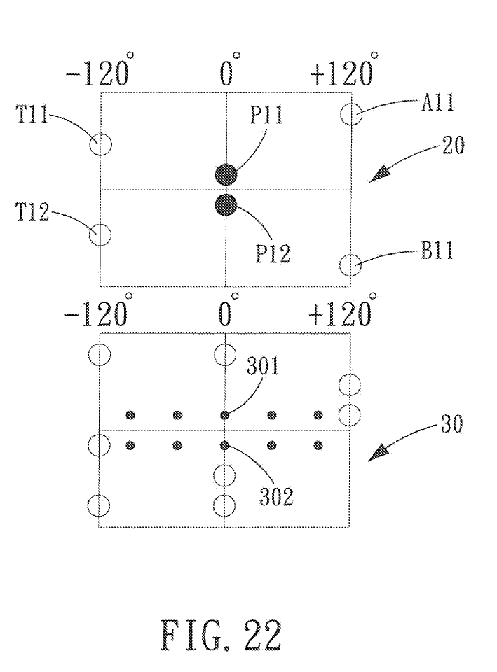

Referring to FIGS. 19-22, a hydraulic rotary valve in accordance with another embodiment of the present invention also comprises a valve body 20 and is similar to the previous embodiment except that:

The spool 30 is further formed with a plurality of first pressure balance ports 301 and second pressure balance ports 302. When the spool 30 rotates to the first angle (0 degree), namely, the so-called neutral position, one of the first pressure balance ports 301 is in communication with the first hydraulic liquid source outer port P11, and one of the second pressure balance ports 302 is in communication with the second hydraulic liquid source outer port P12. By such arrangements, the pressure of the spool 30 in the rotary space 21 of the valve body 20 can be balanced, so that the pressure of the hydraulic liquid inputted by the first and second hydraulic liquid source outer ports P11, P12 can be prevented from becoming too big since the spool 30 won't be able to rotate in the rotary space 21 when the pressure of the hydraulic liquid therein is too big.

Similarly, in accordance with another embodiment of the present invention, even if the spool 30 isn't rotated to the first, second and third angles, the hydraulic rotary valve also has the same function as the previous embodiment, as long as one of the one of the first pressure balance ports 301 is in communication with the first hydraulic liquid source outer port P11, and one of the second pressure balance ports 302 is in communication with the second hydraulic liquid source outer port P12.

Finally, various hydraulic rotary valves with different types of neutral position function can be designed to meet different demands.

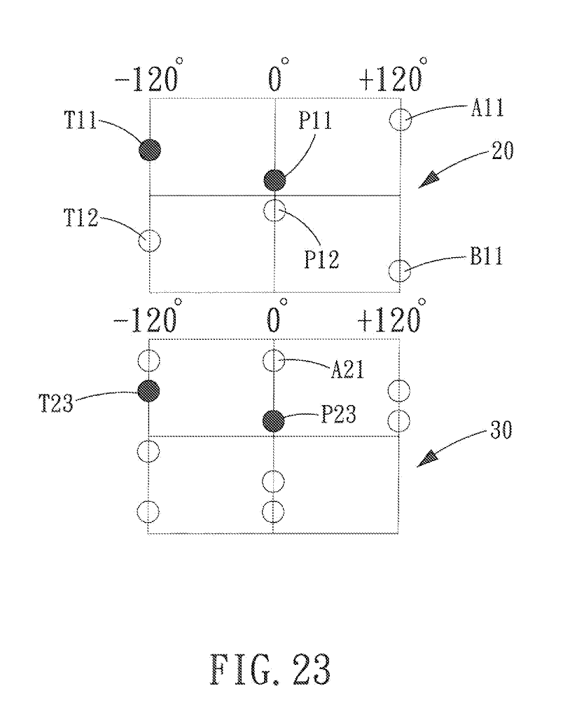

For example, it can be a hydraulic rotary valve with M type neutral position function as shown in FIG. 23, wherein the spool 30 rotates to the first angle (0 degree), the inner ports are in communication with the outer ports, and the overlapped areas between the ports are filled with black color to show the communication state. The spool 30 further comprises a third hydraulic liquid source inner port P23 and a third oil tank inner port T23 which are in communication with the first drive inner port A21. When the spool 30 is rotated to the first angle (0 degree), the third hydraulic liquid source inner port P23 is in communication with the first hydraulic liquid source outer port P11, and the third oil tank inner port T23 is in communication with the first oil tank outer port T11.

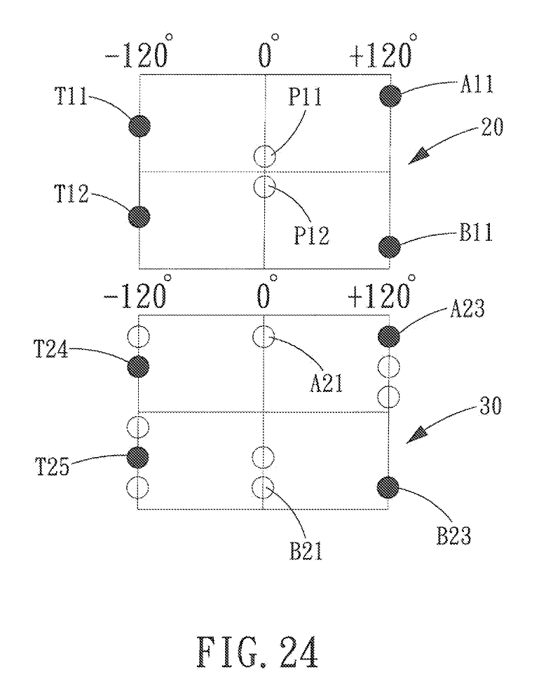

FIG. 24 shows a hydraulic rotary valve with YP type neutral function, wherein the spool 30 rotates to the first angle (0 degree), the inner ports are in communication with the outer ports, and the overlapped areas between the ports are filled with black color to show the communication state. The spool 30 further comprises a wherein the spool 30 rotates to the first angle (0 degree), the inner ports are in communication with the outer ports, and the overlapped areas between the ports are filled with black color to show the communication state. The spool 30 further comprises a fifth drive inner port A23 and a fourth oil tank inner port T24 which are in communication with the first drive inner port A21, and a sixth drive inner port B23 and a fifth oil tank inner port T25 which are in communication with the third drive inner port B21. When the spool rotates to the first angle (0 degree), the fifth drive inner port A23 is communication with the first drive outer port A11, the fourth oil tank inner port T24 is in communication with the first oil tank outer port T11, the sixth drive inner port B23 is in communication with the second drive outer port B11, and the fifth oil tank inner port T25 is in communication with the second oil tank outer port T12.

The hydraulic rotary valve in accordance with the present invention can also have other types of neutral function, namely, the spool further comprises a plurality of drive inner ports, hydraulic liquid source inner ports and oil tank inner ports. When the spool rotates to a first angle, the respective drive inner ports, hydraulic liquid source inner ports and oil tank inner ports are in or not in communication with the hydraulic liquid source outer ports, the oil tank outer ports, and the drive outer ports, respectively, to make the hydraulic liquid flow in the predetermined direction, thus controlling the actuator to perform predetermined motions when the spool is rotated to the first angle.

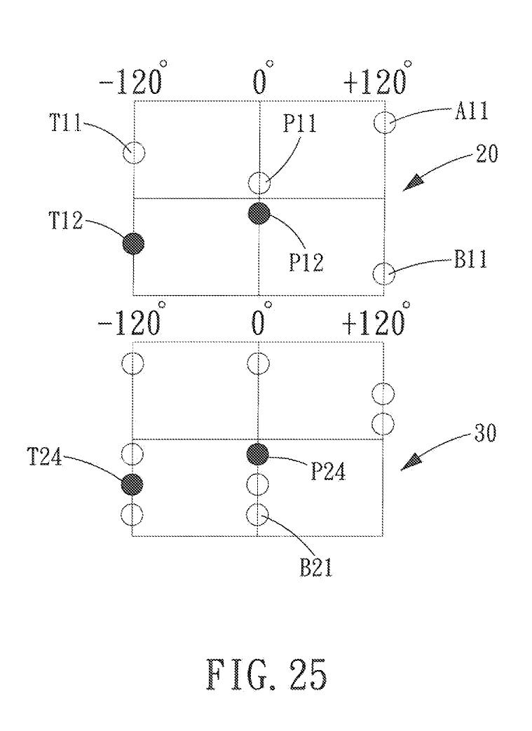

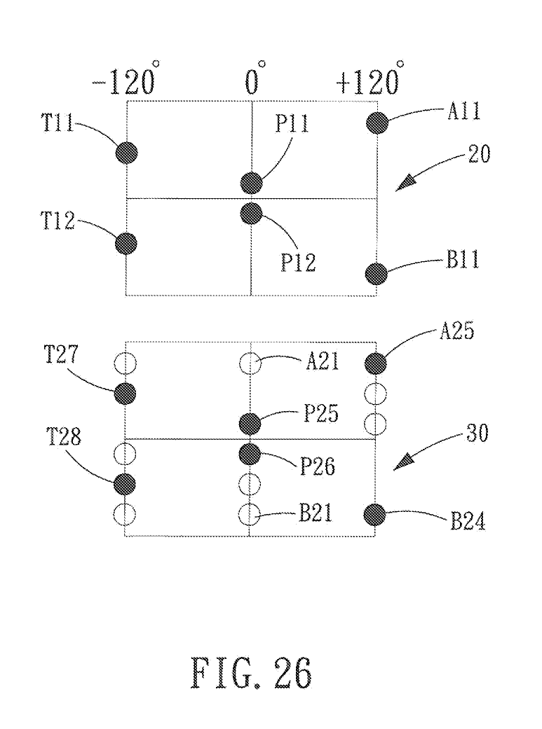

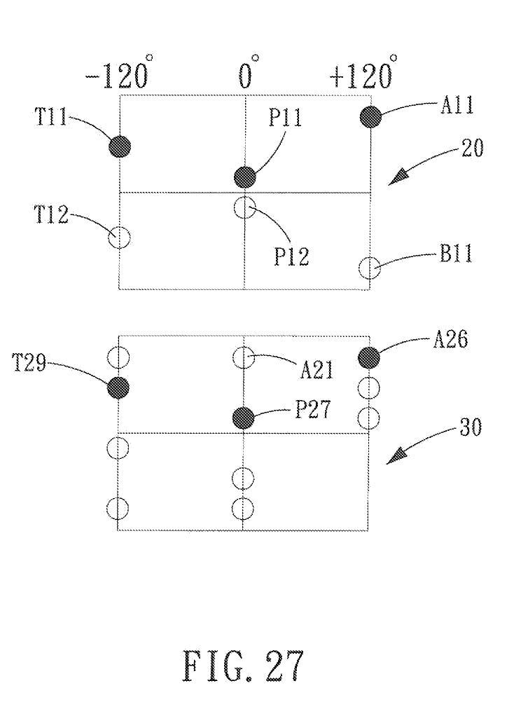

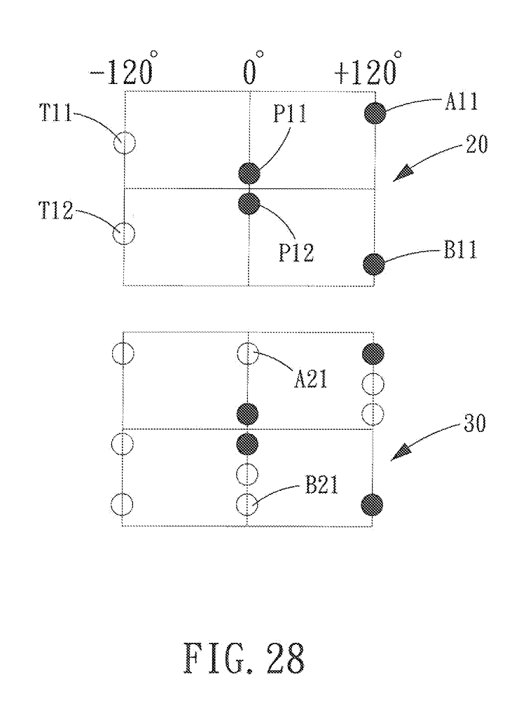

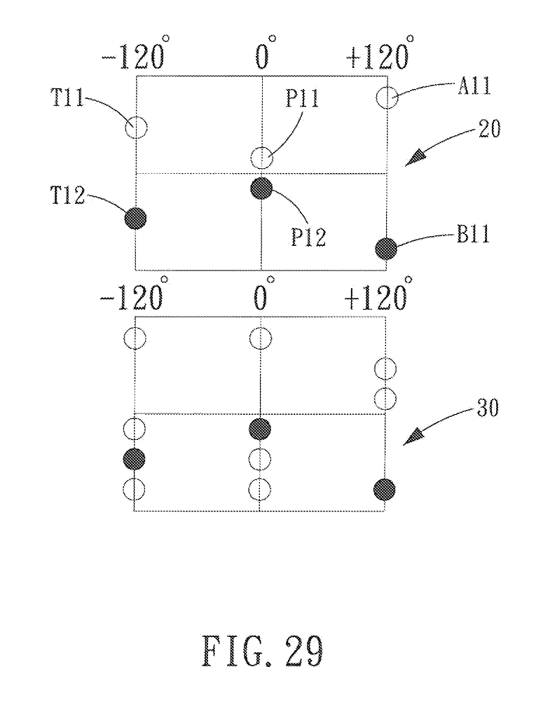

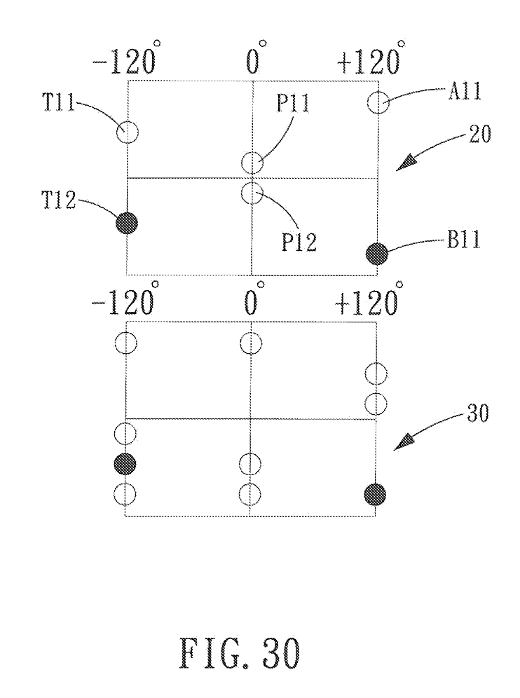

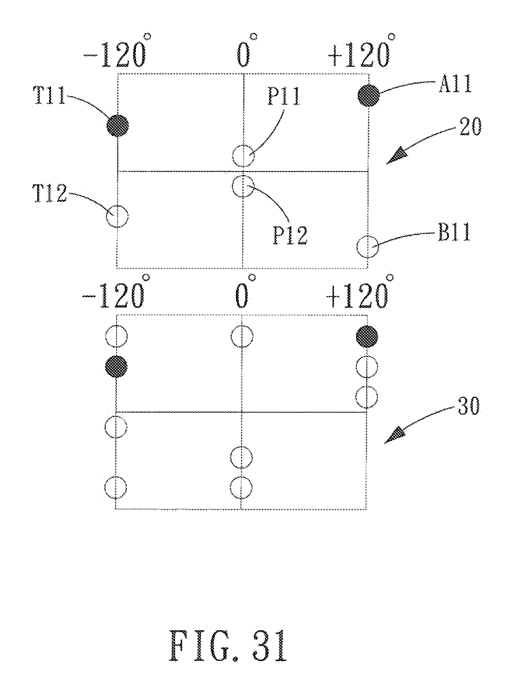

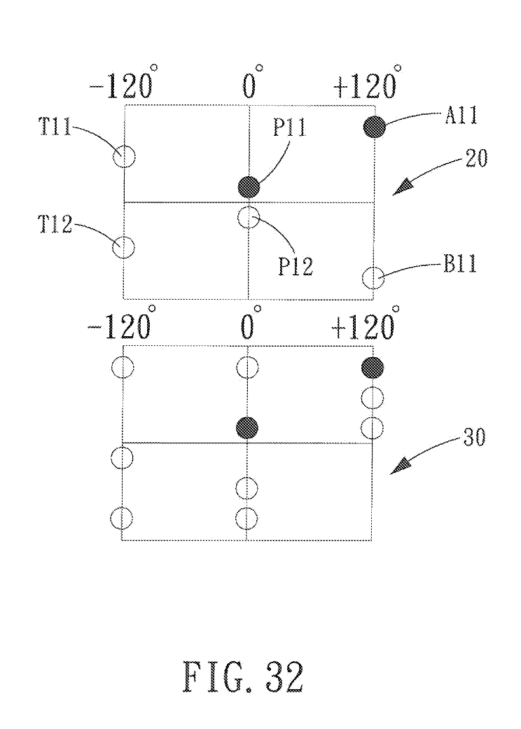

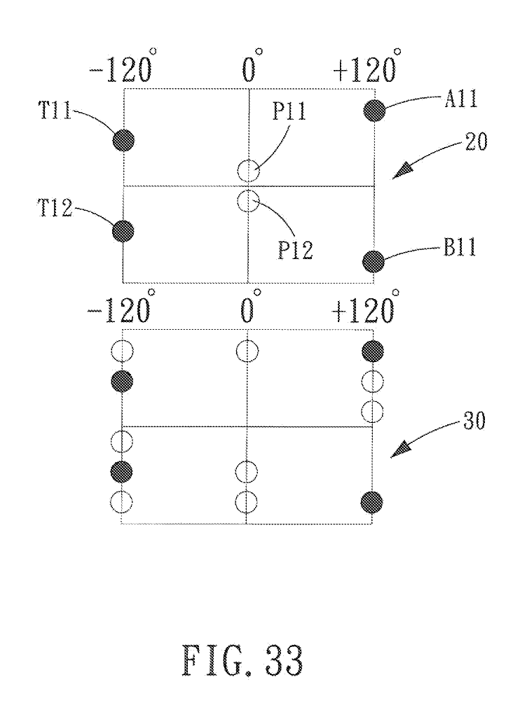

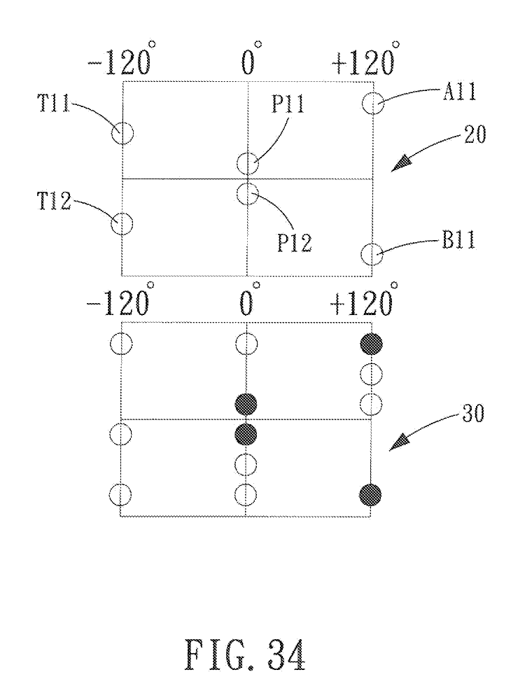

FIGS. 25-34 show various hydraulic rotary valves with “M”, “H”, “K”, “P”, “D”, “J”, “N”, “C”, “Y”, “PY” type neutral functions, wherein the inner ports are in communication with the outer ports, and the overlapped areas between the ports are filled with black color to show the communication state.

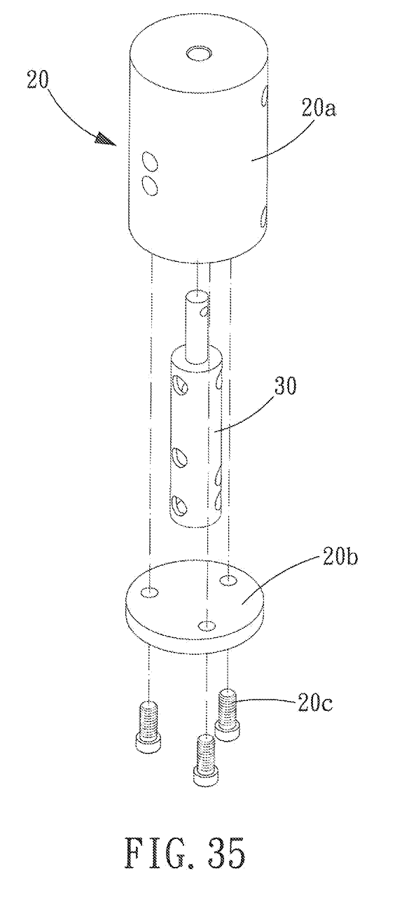

Referring to FIG. 35, another embodiment of the present invention is shown, wherein the valve body 20 comprises a body 20a and a cover 20b fixed to a bottom of the body 20a by screws 20c, and the spool 30 is rotatably disposed in the rotary space 21.

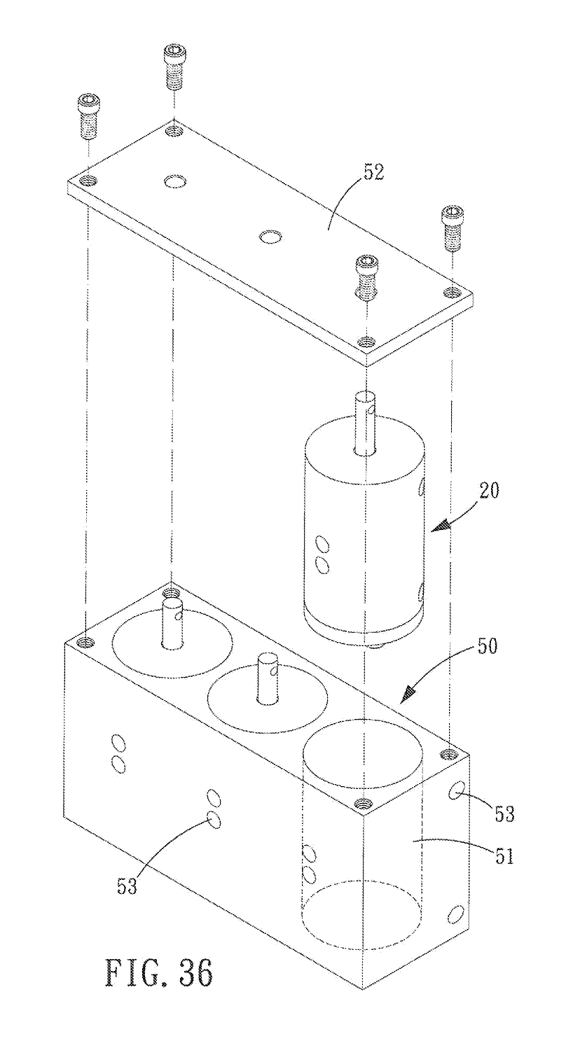

Referring to FIG. 36, another embodiment of the present invention further comprises a block 50 which is provided with a plurality of receiving spaces 51 and a top cover 52 for sealing the receiving spaces 51. Each of the receiving spaces 51 is used to accommodate a hydraulic rotary valve body 20, and the block 50 is further formed with through holes 53 for communicating with the respective outer ports of the hydraulic rotary valve body 20, so that the present invention is capable of controlling multiple actuators.

While we have shown and described various embodiments in accordance with the present invention, it is clear to those skilled in the art that further embodiments may be made without departing from the scope of the present invention.

What is claimed is:

1. A hydraulic rotary valve comprising:
a valve body including at least one rotary space, one first hydraulic liquid source outer port, one second hydraulic liquid source outer port, one first oil tank outer port, one second oil tank outer port, one first drive outer port and one second drive outer port;
at least one spool rotatable received in the rotary space of the valve body and including an axial portion, a control portion extending from the axial portion and into the rotary space, a first hydraulic liquid source inner port, a first oil tank inner port, a first drive inner port, which are in communication with one another and formed in the axial portion, and a second hydraulic liquid source inner port, a second oil tank inner port, a third drive inner port and a fourth drive inner port which are in communication with one another and formed in the axial portion, the spool being capable of rotating at least three angles with respect to the valve body to enable the respective outer ports of the valve body to be in or not in communication with the respective inner ports of the spool, thus making the hydraulic liquid flow in desired directions to control predetermined motions of an actuator.

2. The hydraulic rotary valve as claimed in claim 1, wherein when the spool rotates to a second angle of the at least three angles, the first hydraulic liquid source inner port is in communication with the first hydraulic liquid source outer port, the second drive inner port is in communication with the first drive outer hole, the second oil tank inner port is in communication with the second oil tank outer port, and the fourth drive inner port is in communication with the second drive outer port, when the spool is rotated to a third angle, the first oil tank inner port is in communication with the first oil tank outer port, the first drive inner port is in communication with the first drive outer port, the second hydraulic liquid source inner port is in communication with a second hydraulic liquid source outer port, and the third drive inner port is in communication with the second drive outer port.

3. The hydraulic rotary valve as claimed in claim 2, wherein when the spool is rotated to a first angle, the respective inner ports of the spool are not in communication with the respective outer ports of the valve body.

4. The hydraulic rotary valve as claimed in claim 3, wherein the spool is further formed with a plurality of first pressure balance ports and second pressure balance ports, when the spool rotates to the first angle, namely, the so-called neutral position, one of the first pressure balance ports is in communication with the first hydraulic liquid source outer port, and one of the second pressure balance ports is in communication with the second hydraulic liquid source outer port.

5. The hydraulic rotary valve as claimed in claim 4, wherein when the spool isn't rotated to the first, second and third angles, one of the one of the first pressure balance ports is in communication with the first hydraulic liquid source outer port, and one of the second pressure balance ports is in communication with the second hydraulic liquid source outer port.

6. The hydraulic rotary valve as claimed in claim 2, wherein the spool further comprises a third hydraulic liquid source inner port and a third oil tank inner port which are in communication with the first drive inner port, when the spool is rotated to a first angle, the third hydraulic liquid source inner port is in communication with the first hydraulic liquid source outer port, and the third oil tank inner port is in communication with the first oil tank outer port.

7. The hydraulic rotary valve as claimed in claim 2, wherein the spool further comprises a fifth drive inner port and a fourth oil tank inner port which are in communication with the first drive inner port, and a sixth drive inner port and a fifth oil tank inner port which are in communication with the third drive inner port, when the spool rotates to a first angle, the fifth drive inner port is communication with the first drive outer port, the fourth oil tank inner port is in communication with the first oil tank outer port, the sixth drive inner port is in communication with the second drive outer port, and the fifth oil tank inner port is in communication with the second oil tank outer port.

8. The hydraulic rotary valve as claimed in claim 1, wherein the first and second hydraulic liquid source outer ports are not in communication with each other and connected to a same hydraulic liquid source.

9. The hydraulic rotary valve as claimed in claim 1, wherein the first and second hydraulic liquid source outer ports is connected with each other by a passage.

10. The hydraulic rotary valve as claimed in claim 2, wherein the spool further comprises a plurality of drive inner ports, hydraulic liquid source inner ports and oil tank inner ports, when the spool rotates to a first angle, the respective drive inner ports, hydraulic liquid source inner ports and oil tank inner ports are in or not in communication with the hydraulic liquid source outer ports, the oil tank outer ports, and the drive outer ports, respectively, to make the hydraulic liquid flow in the predetermined direction, thus controlling the actuator to perform predetermined motions when the spool is rotated to the first angle.
